(19) United States
(12) Patent Application Publication
(10) Pub. No.: US 2016/0323654 A1
(43) Pub. Date: Nov. 3, 2016

(54) RENDERING ADVERTISEMENTS IN A CLIENT DEVICE FOR UNINTERRUPTED MEDIA CONTENT

(71) Applicant: AirWatch LLC, Atlanta, GA (US)

(72) Inventor: Kar Fai Tse, Peachtree Corners, GA (US)

(21) Appl. No.: 15/208,292

(22) Filed: Jul. 12, 2016

Related U.S. Application Data
(63) Continuation of application No. 14/496,357, filed on Sep. 25, 2014.

(51) Int. Cl. H04N 21/81; H04N 21/45; H04N 21/478; H04N 21/41; H04N 21/2665; H04N 21/458; H04N 21/2385

(52) U.S. Cl. CPC H04N 21/812; H04N 21/458; H04N 21/4532; H04N 21/4516; H04N 21/2385; H04N 21/4126; H04N 21/2665; H04N 21/47815

(57) ABSTRACT

Disclosed are various embodiments rendering advertisements in a client device in exchange for obtaining uninterrupted media content. A transmission of a first stream of media content for rendering via a media device is initiated, wherein the first stream of media content comprises media with at least one advertisement. A client device is registered with a device management service in response to a request received from the client device. A rendering of at least one advertisement on the client device is initiated. The transmission from the first stream of media content is changed to a second stream of media content for rendering via the media device, wherein the second stream of media content does not include any advertisements.

### CROSS-REFERENCE TO RELATED APPLICATION

This application is a continuation of and claims the benefit of U.S. patent application Ser. No. 14/496,357, entitled “RENDERING ADVERTISEMENTS IN A CLIENT DEVICE FOR UNINTERRUPTED MEDIA CONTENT,” and filed Sep. 25, 2014, which is hereby incorporated by reference in its entirety.

### BACKGROUND

With the rise in popularity of tablet and mobile computing devices, many people are capable of multitasking while watching television. For example, people navigate the Internet, browse social networking applications, or play video games while a television plays a movie or show in the background. Accordingly, there are now many situations in which two devices having displays are in the same room or are in close proximity.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing illustrating a media device and a client device configured to render an advertisement according to various embodiments of the present disclosure.

FIG. 2 is a drawing of a networked environment employing the media device and the client device of FIG. 1 according to various embodiments of the present disclosure.

FIGS. 3A-B are drawings illustrating embodiments of advertisement delivery to the client device of FIG. 1 and media content delivery to the media device of FIG. 1 according to various embodiments of the present disclosure.

FIGS. 4A-B are drawings illustrating a media device and a client device configured to render an advertisement according to various embodiments of the present disclosure.

FIG. 5 is a flowchart illustrating one example of functionality implemented as portions of a device management application executed in a computing environment in the networked environment of FIG. 2 according to various embodiments of the present disclosure.

FIG. 6 is a schematic block diagram that provides one example illustration of a computing environment employed in the networked environment of FIG. 2 according to various embodiments of the present disclosure.

### DETAILED DESCRIPTION

The present disclosure relates to rendering advertisements in a client device. Specifically, in various embodiments, the advertisements may be rendered by the client device in exchange for obtaining uninterrupted media content on a media device. As discussed above, with the rise in popularity of tablet and mobile computing devices, many people are capable of multitasking while watching television. For example, people navigate the Internet, browse social networking applications, or play video games while a television plays a movie or show in the background. Accordingly, there are now many situations in which two devices having displays are in the same room or are in close proximity.

Media content, such as television shows, movies, etc., are traditionally shown in association with commercials or other advertising content. As people are increasingly becoming accustomed to services that omit advertising (e.g., “premium” channels and Internet-based media providers), it may be beneficial to show advertisements to a user elsewhere, such as on a client device (e.g., smartphone, tablet computer, or desktop computer).

Accordingly, various embodiments described herein cause renderings of one or more advertisements on a client device in exchange for the display of uninterrupted media content on a television or other media device. According to various embodiments, a remote service or a local media device maintains or initiates a transmission of a first stream of media content for rendering using a media device, such as a television, wherein the first stream of media content comprises media with at least one advertisement. A client device, such as a smartphone or a tablet computer, may register with the remote service or the local media device. The remote service or the local media device may initiate a rendering of at least one advertisement on the client device and, in response, may initiate a change in the transmission from the first stream of media content to a second stream of media content for rendering via the media device, wherein the second stream of media content has fewer or no advertisements.

In various embodiments, the at least one advertisement may be shown to the user on the client device simultaneously as the user consumes media content via the media device. In alternative embodiments, the at least one advertisement may be stored in a data store local to the client device for a future rendering. In the following discussion, a general description of the system and its components is provided, followed by a discussion of the operation of the same.

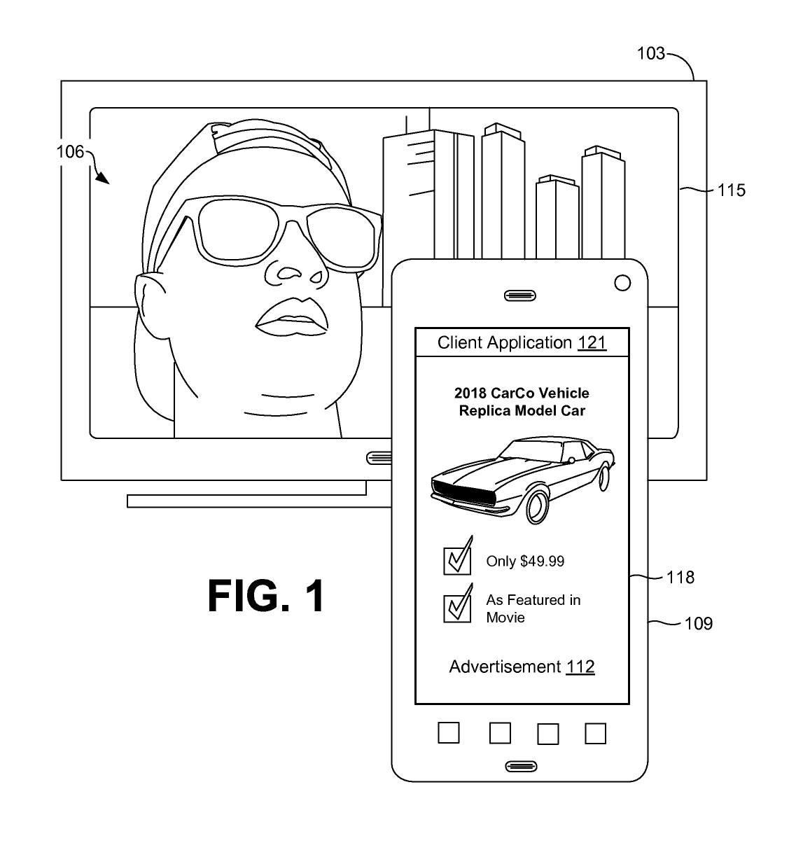

Beginning with FIG. 1, shown is a non-limiting example of a media device 103 rendering media content 106 while a client device 109 simultaneously renders an advertisement 112. According to various embodiments, the media device 103 may comprise a television although, in alternative embodiments, the media device 103 may comprise a set-top-box or another similar device that causes the media content 106 to be rendered by a media device display 115 (e.g., a television display). As may be appreciated, the media content 106 may comprise audio media and/or video media capable of being rendered by the media device 103. To this end, the media content 106 may comprise a movie, a show, a musical album or song, a video clip, etc.

The media content 106 shown in the media device display 115 of the media device 103 may be provided by a media content provider, such as a cable or satellite provider. Further, the media content 106 may be communicated from the media content provider to the media device 103 over a network, such as a cable network or a telecommunications network. If the network comprises a cable network, the media content 103 may be communicated to the media device 103 over one or more cable channels, as may be appreciated.

The client device 109 may comprise, for example, a processor-based system such as a computer system. Such a computer system may be embodied in the form of a desktop computer, laptop computer, personal digital assistant, cellular telephone, smartphone, set-top-box, music player, wearable computing device (e.g., smart watch or GOOGLE® GLASS®), web pad, tablet computer system, game console, electronic book reader, or other device with like capability. In the non-limiting example of FIG. 1, the client device 109 is shown as a smartphone. The client device 109 may include a display 118 capable of showing one or more advertisements 112 to a user. A client application 121 executable on the client device 109 may facilitate enrolling the client device 109 in a service, whereby the user is provided with an uninterrupted stream of media content (e.g., with no advertisements). Further, the client application 121 may facilitate the rendering of the advertisement 112 in the display 118 of the client device 109, as will be discussed in greater detail below.

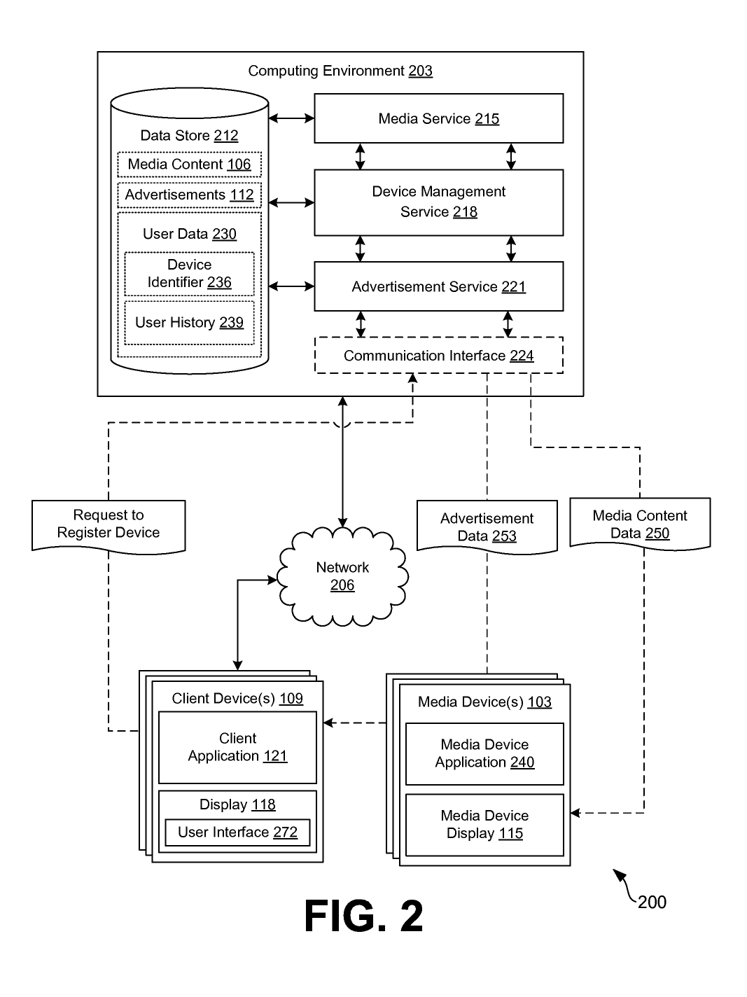

With reference to FIG. 2, shown is a networked environment 200 according to various embodiments. The networked environment 200 includes a computing environment 203, the media device 103, and the client device 109, which are in data communication with each other over a network 206. The network 206 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 203 may comprise, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may comprise a hosted computing resource, a grid computing resource and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in a data store 212 that is accessible to the computing environment 203. The data store 212 may be representative of a plurality of data stores 212 as can be appreciated. The data stored in the data store 212, for example, is associated with the operation of the various applications and/or functional entities described below.

The components executed on the computing environment 203, for example, include a media service 215, a device management service 218, an advertisement service 221, a communication interface 224, and other applications, services, processes, systems, engines, or functionality not discussed in detail herein. The media service 215 is executed to access media content 106 from the data store 212 or from external services, such as those operated by a cable or satellite provider.

The device management service 218 is executed to manage and/or oversee the operation one or more media devices 103 and/or one or more client devices 109. For example, an entity may operate the device management service 218 to ensure that the media devices 103 are receiving media content 106 and the client devices 109 are receiving, viewing, and/or interacting with at least one advertisement 112. Further, the device management service 218 may ensure that the client devices 109 are operated in compliance with one or more compliance rules. The device management service 218 may also facilitate purchasing or consuming an item associated with an advertisement 112.

The advertisement service 221 is executed to identify one or more advertisements 112 from the data store 112 or an external advertisement service to deliver one or more advertisements 112 to the client device 109. The one or more advertisements 112 may be identified based at least in part on the media content 103 presently being consumed by the user, the media content 103 previously consumed by the user, and/or information associated with the user of the client device 109 such as, for example, a purchase history, an application usage history, a browsing history, and/or demographics associated with the user.

The communication interface 224 is executed to facilitate communication between the computing environment 203 and the media device 103 and/or the client devices 109 over the network 206. To this end, the communication interface 224 may comprise an application programming interface (API) embodied in software that facilitates programmatic service calls (e.g., API calls) made by the client devices 109 to communicate with the media service 215, the device management service 218, the advertisement service 221, and/or other services or applications not described herein. According to various embodiments, the web-based API may further comprise a representational state transfer (REST) or a simple object access protocol (SOAP) API.

The data stored in the data store 212 includes, for example, media content 106, advertisements 112, user data 230, and potentially other data. Media content 106 may comprise, for example, data being streamed from an external source, such as a feed of content provided by a cable or satellite content provider. Similarly, media content 106 may comprise audio and/or video data associated with content capable of being played or otherwise consumed via the media device 103. The advertisements 112 include data associated with a notice or announcement, for example, to promote a product, service, event, etc. As may be appreciated, the advertisements 112 may be associated with the media content 106 presently being consumed by one of the media devices 103.

User data 230 includes data associated with one or more users of the media devices 103 and/or the client devices 109. The user data 230 may include a device identifier 236 which may be used to route at least one of the advertisements 112 to a particular one of the client devices 109. Further, the device identifier 236 may be used to authenticate a particular client device 109, as will be discussed in greater detail below. The user data 239 may further include a user history 239 comprising information that may be used to provide a user with targeted advertisements 112. To this end, the user history 239 may include, for example, a purchase history, an application usage history, a browsing history, and/or demographics associated with a particular user.

The client device 109 is representative of a plurality of client devices that may be coupled to the network 206. As discussed above, the client device 109 may comprise, for example, a processor-based system such as a computer system. Such a computer system may be embodied in the form of a desktop computer, a laptop computer, a personal digital assistant, a cellular telephone, a smartphone, a set-top-box, a music player, a web pad, a tablet computer system, a game console, an electronic book reader, or any other device with like capability. The client device 109 may include the display 118. The display 118 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 109 may be configured to execute various applications such as the client application 121 and/or other applications. The client application 121 may be executed in a client device 109, for example, to access network content served up by the computing environment 203 and/or other servers, thereby rendering a user interface 272 on the display 118. To this end, the client application 121 may comprise, for example, a browser, a dedicated application, etc., and the user interface 272 may comprise a network page, an application screen, etc. The client device 109 may be configured to execute applications beyond the client application 121 such as, for example, email applications, social networking applications, word processors, spreadsheets, and/or other applications.

Similar to the client device 109, the media device 103 is representative of a plurality of media devices 103 that may be coupled to the network 206. The media device 103 may comprise, for example, a processor-based system such as a computer system. Such a computer system may be embodied in the form of a set-top-box, a “smart” television, a game console, a laptop computer, a personal digital assistant, a cellular telephone, a smartphone, a music player, a web pad, a tablet computer system, an electronic book reader, or any other device with like capability. The media device 103 may include the media device display 115. The media device display 115 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The media device 103 may be configured to execute various applications such as a media device application 240 and/or other applications. The media device application 121 may be executed in the media device 103, for example, to access network content and/or media content 106 served up by the computing environment 203 and/or other servers, thereby rendering media content 106 on the display 118. To this end, the media device application 240 may comprise, for example, a browser, a dedicated application, etc.

Next, a general description of the operation of the various components of the networked environment 200 is provided. To begin, a transmission of a first stream of media content is maintained or initiated by the device management service 218. The first stream of media content may comprise a stream of content having media and one or more advertisements 112 such as television commercials. Maintenance of the first stream of media content may comprise, for example, sending media content over a communication channel to the media device 103 for rendering on a display. In various embodiments, the first stream of media content is communicated to the media device 103 via a cable channel. In alternative embodiments, the first stream of media content is communicated to the media device 103 via one or more data packets over the network 203 as media content data 250.

As discussed above with respect to FIG. 1, a user, via the client device 109, may register the client device 109 with the device management service 218, for example, by offering to receive one or more advertisements 112 in exchange for obtaining an uninterrupted stream of media content. Accordingly, in response to a request to register the client device 109 being received, the client device 109 is authenticated by the device management service 218. According to various embodiments, authentication of the client device 509 may be carried out to identify a user of the client device 109, a type, model, and/or manufacturer of the client device 109, etc. The identity of the user of the client device 109 and/or the type, model, or manufacturer of the client device 109 may be communicated to the advertisement service 221 (FIG. 2) to obtain targeted advertisements 112 specific to the user and/or the client device 109.

Next, the device management service 218 accesses one or more advertisements 112 from the advertisement services 221 and/or the data store 212 to cause a rendering of one or more advertisements 112 on the client device 109. Initiating or causing a rendering of the one or more advertisements 112 on the client device 109 may include accessing the one or more advertisements 112 from the advertisement service 221 and/or the data store 212, translating the advertisements 112 from a first format incompatible with the client device 109 to a second format compatible with the client device 109, encoding the advertisements 112 in a video or audio stream, and/or sending the advertisements 112 over the network 209 to the client device 109 as advertisement data 253. Further, the device management service 209 may cause the client application 121 to render the one or more advertisements 112 in the display 118 when the advertisements 112 are received and/or at a predefined time in the future.

If the advertisements 112 are to be rendered by the display 118 in the future, the advertisements 112 received by the client device 109 from the device management service 218 may be stored in memory local to the client device 109 by the client application 121. Further, the client application 121 may configure the client device 109 to show the advertisements 112 to the user at a predefined time. In various embodiments, the advertisements 112 may be shown to the user as a wallpaper or a cover screen of the client device 109. In further embodiments, the advertisements 112 may be shown to the user when the user manipulates a particular application. In various embodiments, the advertisements 112 may be shown to the user during short periods of inactivity (e.g., 2-60 seconds), yet while the user remains active on the client device 109.

Upon a transmission of the one or more advertisements 112 to the client device 109, the device management service 218 may determine whether the one or more advertisements 112 have been successfully rendered by the display 118 of the client device 109 or the client device 109 is configured to render the advertisements 112 at a predefined time in the future. If the at least one advertisements 112 has not been rendered by the display 118 or the client device 109 has not been configured to render the advertisements 112 at the predefined time in the future, the transmission of the first stream of media content is initiated or maintained. Alternatively, if the one or more advertisements 112 have been successfully rendered by the display 118 of the client device 109, or the client device 109 is configured to render the advertisements 112 at a predefined time in the future, the transmission of the first stream of media content (e.g., having advertisements), is switched to a second stream of media content having uninterrupted media with fewer or no advertisements. In various embodiments, this may comprise causing the media device 103 to change from a first cable channel to a second cable channel that may have been previously inaccessible. In alternative embodiments, the second stream of media content may be communicated as media content data 250 over the network 206.

Further, the device management service 218 may monitor the activity of the client device 109, for example, to determine whether a user is active or inactive. Monitoring activity may include determining whether any input (e.g., peripheral input or touch screen input) has been received from a user, utilizing a camera and/or microphone to determine whether a user is in the same room as the client device 109, requiring a user to provide user input indicating that the user is active, identifying whether a screen of the client device 109 is turned on, etc. As may be appreciated, monitoring the activity of the client device 109 can be utilized to ensure advertisers that users are actually viewing, listening, or otherwise engaging with the advertisement 112. If the user continues to stay active, the device management service 218 continues to monitor the client device 109. However, if the user becomes inactive, the transmission of the second stream of media content may be reverted back to the first stream of media content.

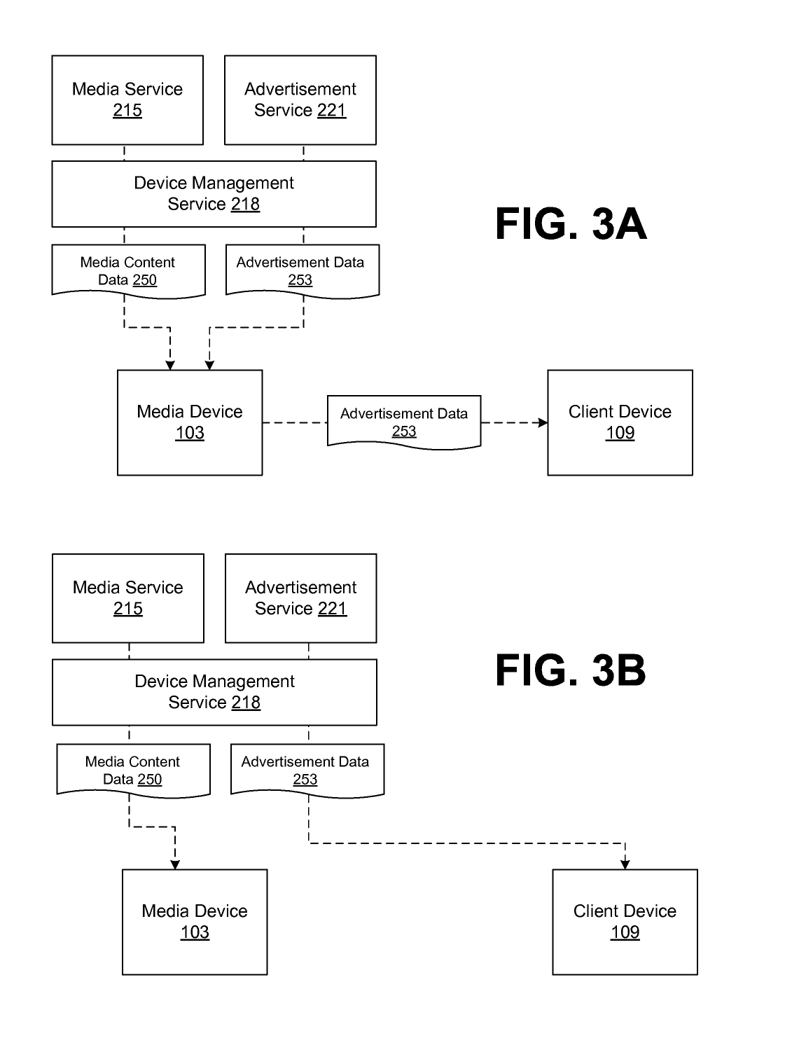

Referring next to FIG. 3A, shown is an embodiment of advertisement delivery according to various embodiments of the present disclosure. As discussed above with respect to FIG. 2, media content 106 may be delivered from the media service 215 to the media device 103 over the network 203 (FIG. 2) or over a cable communication network. Similarly, advertisement data 253 may be delivered from the advertisement service 218 to the client device 109 over the network 203 or over a cable communication network. However, as shown in FIG. 3A, the media device 103 may be configured to receive both the media content data 250 (comprising the media content 106) and the advertisement data 253 (comprising the one or more advertisements 112).

In the non-limiting example of FIG. 3A, the advertisements 112 are not communicated directly to the client device 109 over the network 203. Instead, the media device 103 acts as an intermediary device. Accordingly, in various embodiments, the media device 103 may communicate the advertisement data 253 to the client device 109 using various technologies such as a BLUETOOTH® interface, ZYGBEE® interface, near field communication (NFC) interface, infrared interface, or any other suitable technology. This may require pairing the client device 109 with the media device 103. Further, in this embodiment, the media device 103 may be employed to monitor the activity of the client device 109 on behalf of and at the direct of the device management service 218. The media device 103 may be configured to revert the transmission of the second stream of media content back to the first stream of media content upon an indication of user inactivity on the client device 109. For example, assuming the media device 103 were a set-top-box, the media device 103 may be configured to switch from a first cable channel with advertisements to a second cable channel without advertisements.

Turning now to FIG. 3B, shown is an alternative embodiment of advertisement delivery. In the non-limiting example of FIG. 3B, media content 106 may be delivered from the media service 215 to the media device 103 over the network 203 (FIG. 2) or over a cable communication network. However, as shown in FIG. 3B, the media device 103 may be configured to receive the media content data 250 (comprising the media content) while the client device 109 is configured to receive the advertisement data 253 (comprising the one or more advertisements 112). In the non-limiting example of FIG. 3B, the advertisements 112 are communicated directly to the client device 109 over the network 203.

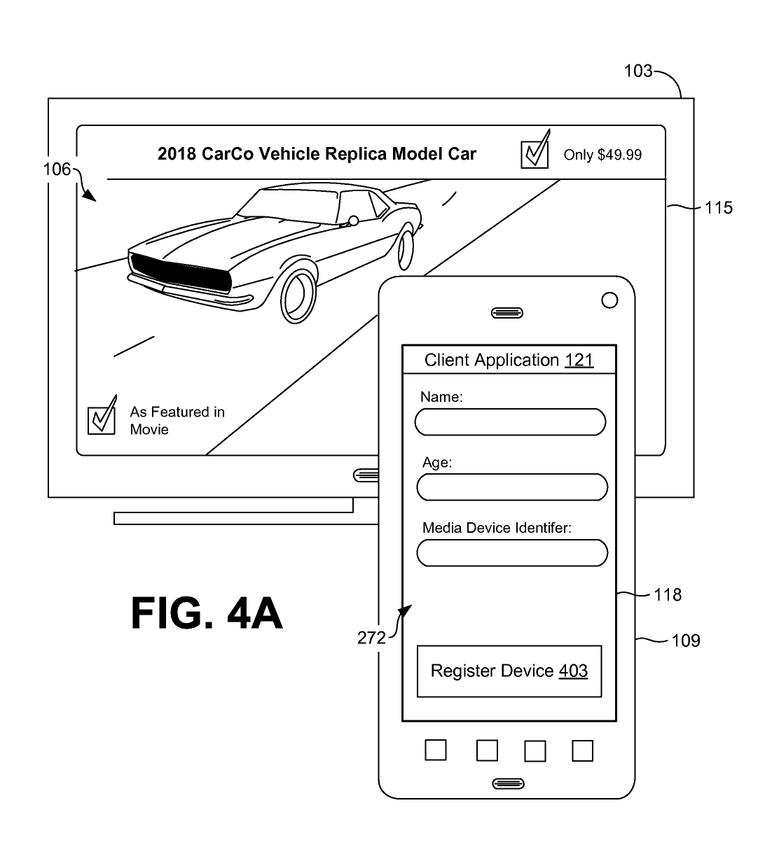

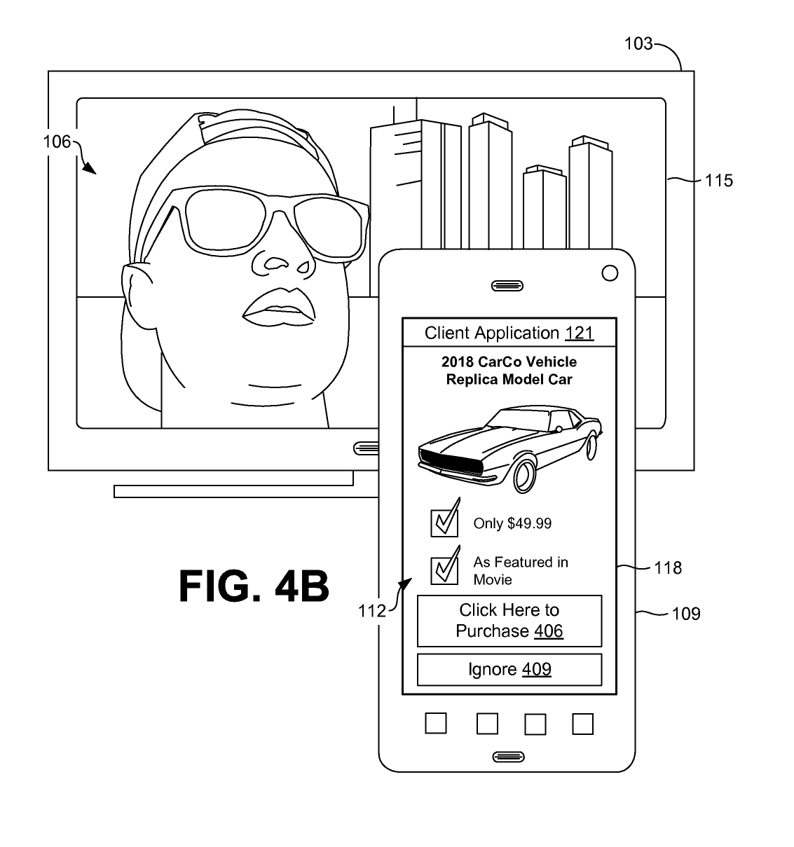

Moving on to FIG. 4A, shown is a non-limiting example of a media device 103 rendering the first stream of media content 106 that comprises at least one advertisement 112. In FIG. 4A, the client device 109 is shown executing the client application 121 that is configured to register the client device 109 with the device management service 218 (FIG. 2). According to various embodiments, the client application 121 may obtain user input from the user of the client device 109 via the user interface 272. To this end, the device management service 218 may obtain information from the user such as a name, age, sex, payment information, or preferences associated with the user. As may be appreciated, this information may be useful in obtaining advertisements 112 to present to the user that are customized for the user. In various embodiments, the client application 121 is able access particular features of or data stored on the client device 121 to obtain information about the user or the client device 109.

In various embodiments, the user interface 272 may prompt the user to provide a mobile device identifier that can be used by the device management service 218 to control the transmission of the second stream of media content having no advertisements. Accordingly, the media device 103 may have a unique identifier that may be accessed by the device management service 218 and stored in the data store 212. By engaging a register device component 403 of the user interface 272, a request comprising all or a portion of the information provided in the user interface 272 may be sent to register the client device 109 with the device management service 215. As will be described in greater detail below, receipt of the request may cause the device management service 218 to change the transmission of the first stream of media content 106 to a second stream of media content 106 having no advertisements 112. In addition, the request may cause the device management service 218 to send one or more advertisements 112 to the client device 109 for rendering in the display 118.

As discussed above, the media content 106 shown in the media device display 115 of the media device 103 may be provided by a media content provider, such as a cable or satellite provider. Further, the media content 106 may be communicated from the media content provider to the media device 103 over a network, such as a cable network or a telecommunications network. If the network comprises a cable network, the media content 103 may be communicated to the media device 103 over one or more cable channels, as may be appreciated.

Turning now to FIG. 4B, shown is the media device 103 rendering media content 106 after a registration or an enrollment of the client device 109 with the device management service 218. In various embodiments, a stream of media content 106 with few or no commercials may be rendered by the media device 103 as the advertisement 112 is rendered by the display 118 of the client device 109. In alternative embodiments, the stream of media content 106 with few or no commercials may be shown to the user when the advertisement 112 has been stored on the client device 109 and the client device 109 has been configured to show the advertisement 112 at a predefined time in the future.

Further, as shown in FIG. 4B, the client application 121 may facilitate an interaction with the one or more advertisements 112 rendered by the display 118 of the client device 109. For example, the user may manipulate a click to purchase component 406 to initiate a purchase (or other consumption) of an item associated with the advertisement 112. In various embodiments, the user may be able to remove the advertisement 112 from being shown on the display 118 by manipulating an ignore component 409. Any user interaction with the advertisements 112 may be measured by the client application 121 and sent to the computing environment 203.

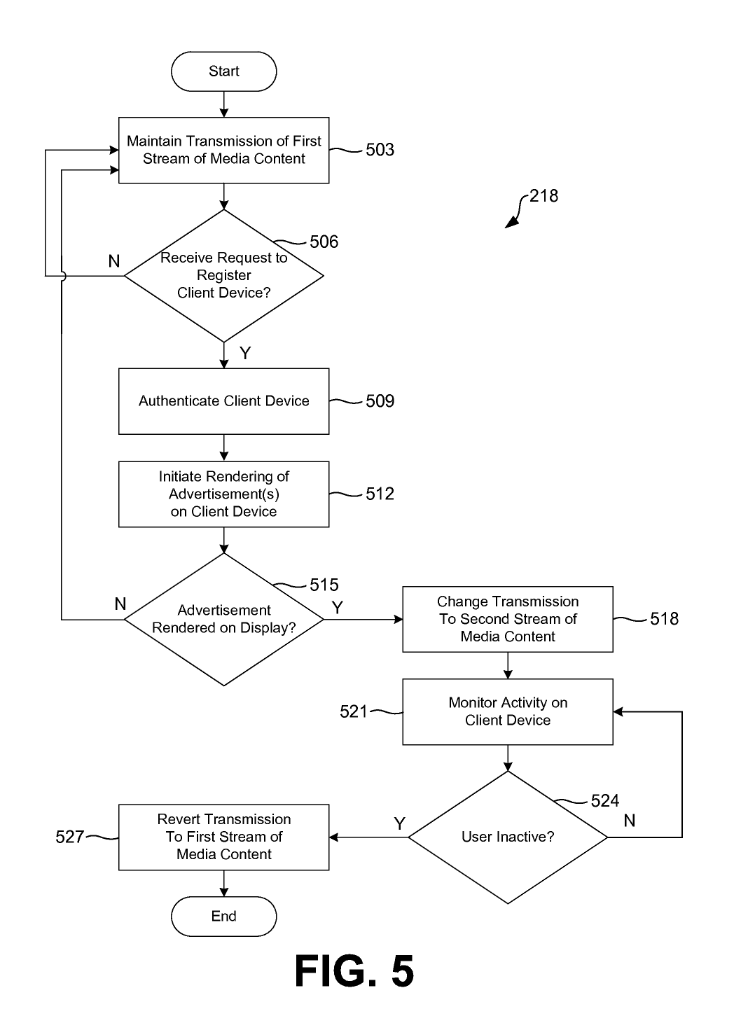

Referring next to FIG. 5, shown is a flowchart that provides one example of the operation of a portion of the device management service 218 according to various embodiments. It is understood that the flowchart of FIG. 5 provides merely an example of the many different types of functional arrangements that may be employed to implement the operation of the portion of the device management service 218 as described herein. As an alternative, the flowchart of FIG. 5 may be viewed as depicting an example of elements of a method implemented in the computing environment 203 (FIG. 2) according to one or more embodiments.

Beginning with 503, a transmission of a first stream of media content is maintained by the device management service 218. With respect to FIG. 5, the first stream of media content is described as being a stream of content having media and one or more advertisements 112 (e.g., television commercials). Maintenance of the first stream of media content may comprise, for example, sending media content over a communication channel to the media device 103 for rendering on a display. In various embodiments, the first stream of media content is communicated to the media device 103 via a cable channel. In alternative embodiments, the first stream of media content is communicated to the media device 103 via one or more data packets over the network 203 (FIG. 2).

In 506, it is determined whether a request to register the client device 109 has been received by the device management service 218. According to various embodiments, the request received by the device management service 218 may be rerouted to a content provider such as a cable or a satellite content provider. If the request to register the client device 109 has not been received, the process continues to 503 whereby the transmission of the first stream of media content is maintained without interruption. However, if the request to register the client device 109 is received, the process may continue to 509, wherein the client device 109 is authenticated. According to various embodiments, authentication of the client device 509 may be carried out to identify a user of the client device 109; a type, model, and/or manufacturer of the client device 109; etc. The identity of the user of the client device 109 and/or the type, model, or manufacturer of the client device 109 may be communicated to the advertisement service 221 (FIG. 2) to obtain targeted advertisements 112 specific to the user and/or the client device 109.

In 512, a rendering of one or more advertisements 112 on the client device 109 is initiated or caused by the device management service 218. Initiating or causing a rendering of the one or more advertisements 112 on the client device 109 may include accessing the one or more advertisements 112 from the advertisement service 221, translating the advertisements 112 from a first format to a second format, encoding the advertisements 112 in a stream, and/or sending the advertisements 112 over the network 209 to the client device 109. Initiating the rendering of the one or more advertisements 112 on the client device 109 may include communicating with the advertisement service 221 to identify one or more advertisements 112 that are associated with the media content 103 being consumed by the user and/or information associated with the user of the client device 109 such as, for example, a purchase history, an application usage history, a browsing history, and/or demographics associated with the user.

Further, the device management service 209 may cause the client application 121 to render the one or more advertisements 112 in the display 118 when the advertisements 112 are received and/or at a predefined time in the future.

Moving on to 515, it is determined whether at least one advertisement 112 has been successfully rendered by the display 118 of the client device 109 or, in the alternative, whether the client device 109 is configured to display the at least one advertisement 112 at a predefined time in the future. If the at least one advertisements 112 has not been rendered by the display 118 or if the client device 109 has not been configured to display the at least one advertisement 112 at a predefined time in the future, the process may proceed to 503, whereby the transmission of the first stream of media content is maintained. Alternatively, if the at least one advertisement 112 has been successfully rendered by the display 118 of the client device 109 or the client device 109 is configured to display the at least one advertisement 112 at a predefined time in the future, the process may proceed to 518. In 518, the transmission of the first stream of media content (e.g., having advertisements), is switched to a second stream of media content having uninterrupted media with fewer or no advertisements.

In 521, the activity of the client device 109 may be monitored, for example, to determine whether a user is or is not active on the client device 109. Monitoring activity may include determining whether any input (e.g., peripheral input or touch screen input) has been received from a user, utilizing a camera and/or microphone to determine whether a user is in the same room as the client device 109, requiring a user to provide user input indicating that the user is active, etc. In various embodiments, determining whether a user is active may include determining whether a degree of user interaction with the client device 109 meets a predefined threshold. As may be appreciated, monitoring the activity of the client device 109 can be utilized to ensure advertisers that users are actually viewing, listening, or otherwise engaging with the advertisement 112.

If the user continues to stay active, the process continues to monitor the client device 109 in 521. However, if the user becomes inactive, the process may proceed to 527 where the transmission of the second stream of media content is reverted back to the first stream of media content.

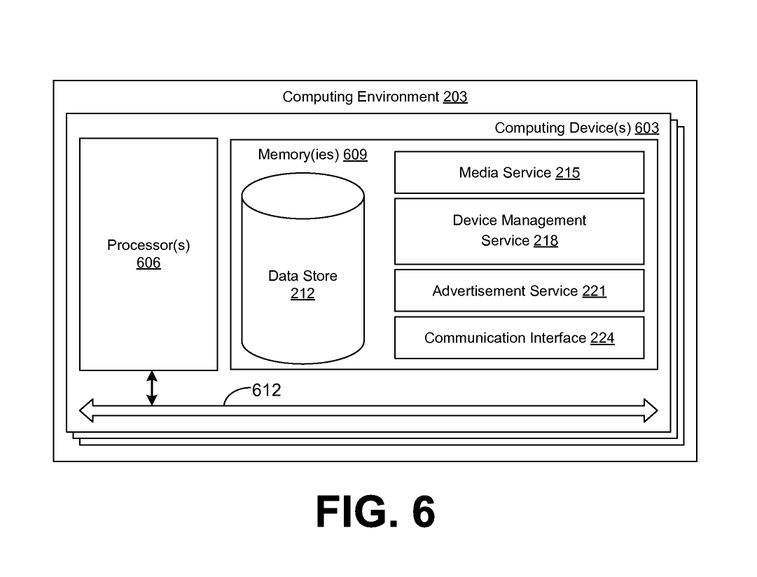

With reference to FIG. 6, shown is a schematic block diagram of the computing environment 203 according to an embodiment of the present disclosure. The computing environment 203 includes one or more computing devices 603. Each computing device 603 includes at least one processor circuit, for example, having a processor 606 and a memory 609, both of which are coupled to a local interface 612. To this end, each computing device 603 may comprise, for example, at least one server computer or like device. The local interface 612 may comprise, for example, a data bus with an accompanying address/control bus or other bus structure as can be appreciated.

Stored in the memory 609 are both data and several components that are executable by the processor 606. In particular, stored in the memory 609 and executable by the processor 606 are the media service 215, the device management service 218, the advertisement service 221, the communication interface 224, and potentially other applications. Also stored in the memory 609 may be a data store 212 and other data. In addition, an operating system may be stored in the memory 609 and executable by the processor 606.

It is understood that there may be other applications that are stored in the memory 609 and are executable by the processor 606 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 609 and are executable by the processor 606. In this respect, the term “executable” means a program file that is in a form that can ultimately be run by the processor 606. Examples of executable programs may be, for example, a compiled program that can be translated into machine code in a format that can be loaded into a random access portion of the memory 609 and run by the processor 606, source code that may be expressed in proper format such as object code that is capable of being loaded into a random access portion of the memory 609 and executed by the processor 606, or source code that may be interpreted by another executable program to generate instructions in a random access portion of the memory 609 to be executed by the processor 606, etc. An executable program may be stored in any portion or component of the memory 609 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 609 is defined herein as including both volatile and nonvolatile memory and data storage components. Volatile components are those that do not retain data values upon loss of power. Nonvolatile components are those that retain data upon a loss of power. Thus, the memory 609 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 606 may represent multiple processors 606 and/or multiple processor cores and the memory 609 may represent multiple memories 609 that operate in parallel processing circuits, respectively. In such a case, the local interface 612 may be an appropriate network that facilitates communication between any two of the multiple processors 606, between any processor 606 and any of the memories 609, or between any two of the memories 609, etc. The local interface 612 may comprise additional systems designed to coordinate this communication, including, for example, performing load balancing. The processor 606 may be of electrical or of some other available construction.

Although the media service 215, the device management service 218, the advertisement service 221, the communication interface 224, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 5 shows the functionality and operation of an implementation of portions of the device management service 218 and potentially portions of the media service 215, the advertisement service 221, and/or the communication interface 224. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 606 in a computer system or other system. The machine code may be converted from the source code, etc. If embodied in hardware, each block may represent a circuit or a number of interconnected circuits to implement the specified logical function(s).

Although the flowchart of FIG. 5 shows a specific order of execution, it is understood that the order of execution may differ from that which is depicted. For example, the order of execution of two or more blocks may be scrambled relative to the order shown. Also, two or more blocks shown in succession in FIG. 5 may be executed concurrently or with partial concurrence. Further, in some embodiments, one or more of the blocks shown in FIG. 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the media service 215, the device management service 218, the advertisement service 221, and/or the communication interface 224, that comprises software or code can be embodied in any non-transitory computer-readable medium for use by or in connection with an instruction execution system such as, for example, a processor 606 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the media service 215, the device management service 218, the advertisement service 221, and the communication interface 224, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 603, or in multiple computing devices in the same computing environment 203. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
at least one computing device;
program code that, when executed by the at least one computing device, causes the at least one computing device to at least:
identify a stream of media content associated with a user of a client device, the stream of media content comprising a first format, the first format being compatible with a media device associated with the user;
determine whether the user is authorized to access at least one portion of the stream of media content using the client device based at least in part on at least one compliance rule; and,
when the user is authorized to access the at least one portion of the stream of media content using the client device:
causing the at least one portion of the stream of media content to be translated from the first format to a second format, the second format being compatible with the client device; and,
causing the at least one portion of the stream of media content to be accessible to the client device.

2. The system of claim 1, wherein identifying the stream of media content associated with the user of the client device comprises:
identifying a user history associated with the user of the client device, the user history specifying at least one prior use of the client device by the user; and,
identifying a particular stream of media content that the user is authorized to access based at least in part on the user history.

3. The system of claim 2, wherein the at least one prior use of the client device comprises at least one use of a browser application executed by the client device.

4. The system of claim 2, wherein the at least one prior use of the client device comprises at least one financial transaction initiated using the client device.

5. The system of claim 2, wherein the at least one prior use of the client device comprises at least one action indicative of the user of the client device belonging to at least one particular demographic.

6. The system of claim 1, further comprising program code that causes the at least one computing device to:
identify a request to access the at least one portion of the stream of media content using the client device.

7. The system of claim 1, wherein the at least one compliance rule specifies that the user of the client device is only authorized to access the at least one portion of the stream of media content when functionality of the client device is controlled at least in part by a management service.

8. A non-transitory computer-readable medium embodying a program executable in at least one computing device, comprising code that:
identifies a stream of media content associated with a user of a client device, the stream of media content comprising a first media format, the first media format being compatible with a media device associated with the user;
determines whether the user is authorized to access at least one portion of the stream of media content using the client device based at least in part on at least one compliance rule; and,
when the user is authorized to access the at least one portion of the stream of media content using the client device:
causes the at least one portion of the stream of media content to be translated from the first media format to a second media format, the second media format being compatible with the client device; and,
causes the at least one portion of the stream of media content to be accessible to the client device.

9. The non-transitory computer-readable medium of claim 8, wherein the first media format further comprises at least one cable channel.

10. The non-transitory computer-readable medium of claim 8, wherein the second media format further comprises at least one data packet.

11. The non-transitory computer-readable medium of claim 10, wherein the at least one data packet comprises a video stream.

12. The non-transitory computer-readable medium of claim 10, wherein the at least one data packet comprises an audio stream.

13. The non-transitory computer-readable medium of claim 8, wherein identifying the stream of media content associated with the user of the client device comprises:
identifying at least one characteristic describing the client device; and,
identifying a particular stream of media content that the user is authorized to access based at least in part on the at least one characteristic describing the client device.

13. The non-transitory computer-readable medium of claim 8, wherein the at least one characteristic describing the client device comprises at least one of: a device type of the client device, a device model of the client device, or a device manufacturer of the client device.

14. A method, comprising:
identifying a stream of media content associated with a user of a client device, the stream of media content comprising a first media format, the first media format being compatible with a media device associated with the user;
determining whether the user is authorized to access at least one portion of the stream of media content using the client device based at least in part on at least one compliance rule; and,
when the user is authorized to access the at least one portion of the stream of media content using the client device:
causing the at least one portion of the stream of media content to be translated from the first media format to a second media format, the second media format being compatible with the client device; and,
causing the at least one portion of the stream of media content to be accessible to the client device.

15. The method of claim 14, further comprising:
when the user is not authorized to access the at least one portion of the stream of media content using the client device, causing the at least one portion of the stream of media content to be inaccessible to the client device.

16. The method of claim 16, wherein causing the at least one portion of the stream of media content to be inaccessible to the client device comprises causing the at least one portion of the stream of media content to be erased from the client device.

17. The method of claim 16, wherein causing the at least one portion of the stream of media content to be inaccessible to the client device comprises locking at least one function of the client device.

18. The method of claim 16, wherein causing the at least one portion of the stream of media content to be inaccessible to the client device comprises causing the execution of at least one application by the client device to be terminated.

19. The method of claim 16, wherein causing the at least one portion of the stream of media content to be inaccessible to the client device comprises causing at least one application to be installed or upgraded on the client device.
